(19) United States
(12) Patent Application Publication
(10) Pub. No.: US 2010/0022787 A1
(43) Pub. Date: Jan. 28, 2010

(54) PLANT OILS AND APPARATUS AND METHOD FOR THE PREPARATION OF PLANT OILS

(76) Inventors: William E. Vincent, Brandon (CA); Barry Wayne Comis, Delta (CA)

Correspondence Address: MOORE & VAN ALLEN PLLC, P.O. BOX 13706, Research Triangle Park, NC, 27709, US

(21) Appl. No.: 12/264,018

(22) Filed: Nov. 3, 2008

Related U.S. Application Data
(60) Provisional application No. 61/083,801, filed on Jul. 25, 2008.

(30) Foreign Application Priority Data
Nov. 3, 2008 (CA) 2,642,677

(51) Int. Cl. C11B 1/10; C08G 63/48; A23N 1/02

(52) U.S. Cl. 554/9; 554/1; 99/510; 241/65

(57) ABSTRACT

There are disclosed preparations of plant oils which may be highly pure, have a low moisture content and may be highly stable. Methods and apparatus for the preparation of the oils may exclude electromagnetic radiation and reactive gasses during the preparation of the oils.

### RELATED APPLICATION

This application claims benefit of co-pending U.S. Provisional Application No. 61/083,801, filed Jul. 25, 2008, and priority under 35 U.S.C. §119(a) to Canadian Patent Application No. ______, filed Nov. 3, 2008 and entitled “Plant Oils And Apparatus And Method For The Preparation Of Plant Oils”, both by the inventors hereof, the entire disclosures of which are incorporated herein by reference.

### FIELD

This disclosure relates to a method and apparatus for extracting plant oils from seeds and plant tissues and to plant oils extracted using the method and apparatus.

### BACKGROUND

A range of methods for the processing of seeds and the extraction of plant oils therefrom are known in the art. U.S. Pat. No. 4,275,089, issued Jun. 23, 1981 to Kopas et al, describes methods for the purification of vegetable oils. US Patent Application 2007/0281044, Mueller & Yu, published Dec. 6, 2007 discloses methods for cold pressing edible seed oils.

### SUMMARY

In an embodiment there may be disclosed a highly stable plant oil having a low moisture content and low peroxide value.

In alternative embodiments the oil may be stable for longer than about two years, and has less than about 200 ppm Karl Fischer moisture.

In alternative embodiments the oil may comprise less than about 200 pm Karl Fischer Moisture.

In alternative embodiments the oil may comprise less than about 100 pm Karl Fischer Moisture.

In alternative embodiments the oil may have a peroxide value of less than about 10 meq/kg.

In alternative embodiments the oil may be prepared in the substantial absence of oxygen and light.

In alternative embodiments the oil may comprise flax oil, olive oil, sunflower oil, or grapeseed oil.

In alternative embodiments there is disclosed a highly stable plant oil having less than about 200 ppm Karl Fischer Moisture.

In alternative embodiments the plant oil may have less than about 100 ppm Karl Fischer Moisture and may have a peroxide value of less than about 10 meq/kg.

In alternative embodiments the plant oil may be substantially stable for longer than two years.

In alternative embodiments the plant oil may comprise olive oil, flax oil, sunflower oil, canola oil or grapeseed oil.

In alternative embodiments the plant oil may herbicides and pesticides may be undetectable in the oil.

In an alternative embodiment there is disclosed a plant oil which may be suitable for human consumption, may be substantially stable for at least three years, and may be essentially free of pesticides and herbicides, and having less than about 100 ppm Karl Fischer Moisture and less than about 10 meq/kg peroxide value.

In alternative embodiments there is disclosed a nutritional supplement comprising the oil according to any one of the embodiments.

In alternative embodiments there is disclosed a method for extracting a plant oil from a seed, the method comprising disrupting the seed and preparing an extract containing the plant oil under conditions which substantially prevent exposure of the oil to reactive gases and to predetermined wavelengths of electromagnetic radiation.

In alternative embodiments the method further may comprise preventing exposure of the oil to electrical currents.

In alternative embodiments the method further may comprise removing lignans from the extract.

In alternative embodiments the method further may comprise displacing the reactive gas with an inert gas.

In alternative embodiments the inert gas may comprise Nitrogen, Argon or Carbon Dioxide.

In alternative embodiments the electromagnetic radiation includes visible light.

In alternative embodiments the visible light includes red light.

In alternative embodiments there is disclosed a plant oil produced according to the method of any of the embodiments.

In alternative embodiments the plant oil may be heated to a temperature of greater than about 75° C. for a predetermined time.

In alternative embodiments there is disclosed apparatus for isolating a plant oil from a seed, the apparatus comprising:
a seed intake unit;
a seed milling unit operatively connected to the seed intake unit for receiving seed from the seed intake unit and producing a first plant oil extract; and
wherein the apparatus substantially prevents exposure of the plant oil to:
   a) oxygen; and
   b) a predetermined range of electromagnetic radiation.

In alternative embodiments the apparatus may prevent exposure of the oil to electrostatic charges.

In alternative embodiments the apparatus may comprise an evaporator to separate the plant oil from any lignans comprised in the plant oil extract.

In alternative embodiments the predetermined range of electromagnetic radiation includes visible light.

In alternative embodiments the light includes red light.

In alternative embodiments the atmospheric air may be displaced by an inert gas to substantially prevent contact between the oil and atmospheric oxygen.

In alternative embodiments the inert gas may comprise Nitrogen, Argon or Carbon Dioxide.

In alternative embodiments there is disclosed a plant oil produced using the apparatus according any one of embodiments.

In alternative embodiments the seed may be selected from the group consisting of: flax, grape, sunflower and olive seeds.

In alternative embodiments the apparatus heats the plant oil to a temperature of greater than about 75° C. for a predetermined time.

Features and advantages of the subject matter hereof will become more apparent in light of the following detailed description of some embodiments, as illustrated in the accompanying figures. As will be realized, the invention is capable of modifications in various respects, all without departing from the invention. Accordingly, the drawings and the description are to be regarded as illustrative in nature, and not as restrictive and the full scope of the subject matter is set forth in the claims.

### BRIEF DESCRIPTION OF DRAWINGS

FIG. 1 is a flow diagram of an embodiment.

FIG. 2 is a part of a milling unit of an embodiment.

FIG. 3 is a close up of the press heads according to FIG. 2.

FIG. 4 is a view of the press heads of FIG. 3 disassembled to show the augers.

FIG. 5 is a boot of an embodiment.

FIG. 6 is a close up of a partly assembled press head.

FIG. 7 is a view of the seed supply to milling units.

FIG. 8 is a side view of a surge tank of an embodiment.

FIG. 9 is an end view from end A of FIG. 8.

FIG. 10 is a side view of a press head according to FIG. 3.

FIG. 11 is a side view of an individual press head according to FIG. 4.

### DETAILED DESCRIPTION OF EMBODIMENTS

### Definitions:

In this disclosure the term “concentrating unit” means any suitable apparatus for increasing the content or purity of a plant oil in an existing plant oil extract or plant oil preparation, and may include one or more clarifiers, concentrating apparatus, distillation apparatus, molecular stills, filter assemblies, sedimentation devices, or any other apparatus suitable to achieve a desired or acceptable level of concentration of the oil or desired components of the oil, or to remove unwanted contaminants therefrom.

In this disclosure the term “container” means and includes bottles, bags, cans, jars or any other form of container suitable for holding a plant oil. In particular embodiments the containers may be adapted to protect plant oil contained therein from exposure to light or to reactive species and the containers may be made of or coated with inert materials and dark, or light excluding or light blocking materials.

In this disclosure the term “dark” or “darkness” means an environment wherein light is substantially or completely excluded and may further include the exclusion of visible and near-visible wavelengths and high energy or other wavelengths which could have the tendency to promote the breakdown of a plant oil. A material is said to be dark if it is able to block the passage of light or other electromagnetic radiation.

In this disclosure the statement that a plant oil is “essentially free” or “substantially free” of pesticides or herbicides means that in embodiments the levels of pesticides and/or herbicides in the plant oil may be minimal and may be below about 0.0001 ppm, below about 0.001 ppm, below about 0.01 ppm, below about 0.1 ppm, below about 1 ppm, below about 10 ppm, below about 100 pm or higher and in embodiments pesticides and herbicides may be undetectable or substantially undetectable or unmeasurable or unquantifiable using standard measuring techniques.

In this disclosure the term “food grade” when applied to seed means any the grade generally considered in the industry, or by those skilled in the art or approved by government or other agencies as suitable for food production or human consumption. By way of example and not limitation where the seed is flax then food grade seed may be Canadian flax of 99.9% purity with seeds of reasonable homogenous size distribution and with few or no broken or white or black seeds in the mixture. In embodiments the seed may be organically grown, may be certified organic, or may be grown under other conditions not generally considered “organic”.

In this disclosure the term “light” is intended to mean and includes all ranges of electromagnetic radiation that may have the effect of forming radicals or reactive species that may deleteriously affect the structure, activity or stability of plant oils. Light may include visible light, ultraviolet light or other electromagnetic wavelengths. It will be understood that certain wavelengths, which may include infra red or other wavelengths of light may not affect the stability, structure or activity of plant oils and therefore in particular alternative embodiments may not be included within the scope of excluded light for the purposes of this application. Terms indicating the exclusion of light from apparatuses or processes disclosed or indicating that processes herein may be carried out in darkness, or similar indications, are likewise limited in scope in ways that will be readily understood by those skilled in the art. In particular embodiments the plant oil or mixtures containing a plant oil may be shielded from electromagnetic radiation with wavelengths of less than about 700 nm, less than about 600 nm, less than about 500 nm, less than about 400 nm, less than about 300 nm, or less than about 200 nm or less than about 100 nm. In particular alternative embodiments the plant oil or mixtures containing a plant oil may be shielded from electromagnetic radiation in the part or all of the visible spectrum, or the ultra violet range or the infra red range.

In this disclosure the term “inert” or “non-reactive” is intended to mean and include materials, including but not limited to metals, plastics, ceramics and other materials, that do not react with or promote reaction of plant oils and do not promote the formation of reactive species, including radicals, or changes or breakdown of plant oil molecules. By way of illustration and not limitation, inert materials may include silicone, PTFE, TEFLON™, stainless steel and inert seals may include EnviroSEAL™, microSEAL™, and Viton™ In some embodiments the chosen non-reactive metals may be or may include one or more of food grade stainless steel, Titanium and Vanadium.

In this disclosure the term “inert gas” is intended to mean and include compositions that may comprise or consist of one or more inert gases and may comprise Carbon Dioxide, Nitrogen, Helium, Argon, Xenon, Krypton, or combinations thereof with each other or with other components. It will be appreciated that for the purposes of this disclosure “inert” means inert with respect to the plant oil to be isolated. The choice of suitable gases for particular stages will be readily made by those skilled in the art with reference to cost and performance requirements.

In this disclosure the terms “inlet” and “outlet” are intended to have their normal meaning and include any port, hole, opening, device, structure, feed, tube, orifice or other means for allowing a substance to pass into or out of (respectively) a space or container.

In this disclosure the term “Low moisture content” with respect to an oil means an oil having a Karl Fischer Moisture content of less than about 200 ppm, less than about 150 ppm, less than about 100 ppm, less than about 90 ppm, less than about 80 ppm, less than about 70 ppm, less than about 60 ppm, less than about 50 ppm, less than about 40 ppm, or less than about 30 ppm.

In this disclosure the term “Low peroxide value” with respect to an oil means an oil having a peroxide value of less than about 20 meq/kg, less than about 15 meq/kg, less than about 10 meq/kg, less than about 9 meq/kg, less than about 8 meq/kg, less than about 7 meq/kg, less than about 6 meq/kg, less than about 5 meq/kg, less than about 4 meq/kg, less than about 3 meq/kg, less than about 2 meq/kg, less than about 1 meq/kg or less than about 0.5 meq/kg.

In this disclosure the term “seed intake unit” means an apparatus for accepting and/or storing seed and may comprise silos, hoppers, blowpipes, augers or any other suitable apparatus.

In this disclosure the term “seed milling unit” means an apparatus for disrupting seed and may be a grinder or press and may be an auger press.

In this disclosure the term “plant oil extract” means an extract of plant material containing a plant oil.

In this disclosure the term “enriched plant oil extract” means a plant oil extract whose relative plant oil content has been increased from its normal representation in the native plant material.

In this disclosure the term “molecular still” is intended to mean an apparatus used to conduct molecular distillation and may include Wiped-Film Molecular (Short-Path) Stills, Wiped Film Evaporators, centrifugal molecular stills, horizontal molecular stills, cyclic molecular stills, falling film molecular stills and the like. It will be understood that in certain embodiments it may be possible to replace the molecular stills disclosed with alternatives. In particular embodiments, for use with particular plant oils, possible alternatives may include flash evaporators, falling film stills, rotary evaporators and other similar equipment. Suitable molecular stills may include those manufactured by Pope Scientific Inc.

In this disclosure the term “concentrating unit” is intended to mean an apparatus for increasing the concentration of plant oil in a plant oil extract or a mixture containing a plant oil and may include one or more clarifiers and may include one or more molecular stills and may include storage tanks, filters and other associated apparatus, all of which will be readily apparent to one skilled in the art.

In this disclosure the term “predetermined wavelength” means ranges of wavelength that have been or can be intentionally selected or have been obstructed or selected for by a suitable opaque, or partially opaque, material. It will be understood that the actual numerical wavelength values may or may not be known, and that the exclusion of wavelength ranges may be determined on an empirical basis by selecting suitable radiation excluding materials that confer the desired improvement of stability on the product rather than actually determining said wavelength values. For greater clarity it will be understood that the selection of a suitable opaque material will necessarily “predetermine” the wavelengths which may be blocked, even though the particular values of those wavelengths may not be known to the user or maker of the apparatus or method.

In this disclosure the term “press” or “seed press” is intended to mean a press or other apparatus for expelling materials from seed and in particular embodiments it may include screw presses, vacuum presses, hydraulic presses, expellers, crushing mills, and may include Taby™ presses and Komet™ presses. “Press” may refer to any one of a range of alternative presses, grinders or other devices may be useable for cracking the seed and may be comprised within the seed milling unit. A range of presses or equivalents may be useable or useable with some suitable adaptations. For the purposes of the embodiments disclosed such may include the FT28 Oil Extraction Screw Press supplied by Armfield Food Technology; the RP45 Oil Press supplied by Diesel X Ltd. & Co. KG www.diesel-x.de; KYP20 press supplied by Baykay Koprulu Machine Ltd.; Screw oil expeller supplied by Shandong Kingstar Machinery Co., Ltd. In some embodiments presses may be of a small head screw type or may be one of a range of Monforts Komet presses. The seed press assemblies may be provided on wheeled mountings. Flexible independent power supply lines may be provided so that presses can be plugged in and operated at any one of a plurality of distribution points on the line.

In this disclosure the term “plant oil” is intended to mean oils derived from seed or plant tissues or portions of seed or plant tissues and may include but is not limited to alpha linolenic (omega-3) acids, linoleic acids (omega-6 and gamma linolenic acid (omega 6 oils), and oleic acids (omega 9 oils), palmitic acids, palmitoleic acids, stearic acids, phenols (which may include tocopherols), sterols (which may include campesterol, beta-sitosterol, stigmasterol), anti-oxidants and radical scavengers, azo compounds, vitamins, Phytoplant oils, Carotenoids (Beta-carotene, Lutein, Zeaxanthin), Flavonoids (Anthocyanidins, (Flavanols, Catechins, Epicatechins, Procyanidins), Proanthocyanidins), plant sterols and stanols and may be saturated or may be mono or poly unsaturated. In particular embodiments, they may comprise flax seed oil, olive oil, sunflower seed oil, blends of flax seed oil, olive oil and sunflower seed oil, blends of flax and sunflower seed oils, or any other seed or plant derived oils. It will be understood that the term “plant oil” as used herein may include oils that are substantially pure, or that are mixed with other oils in any proportions, or may include mixtures of one or more oils with other chemicals or components and that therefore references to oil, or plant oil or the like, includes plant oil extracts and plant oil in any degree of impurity or stage of preparation. The plant oils and mixtures containing plant oils may be suitable for consumption by animals, which may be mammals, and which may be humans.

In this disclosure the term “seed” is intended to mean and include all types of commercially processable seeds (which term includes but is not limited to propagative parts of any plants and includes but is not limited to, cereal seeds, grain, fruits, vegetables, nuts, tubers, spores). Seeds may derive from any species of plant, and possible plant sources include but are not limited to acia, acacia, almond; apple, apricot, artichoke, avocado; beech; blackberry, blackcurrant, brazil, calendula (marigold); cashew; cherry, chia; coconut; cottonseed; corn, dragon fruit, evening primrose; fig, filbert, flax (linseed), gourds, grape, hemp, hickory, kukui (candlenut), macadamia, mango, melon, neem, olive, orange, palm kernel, peach, perilla, peanut, pecan, perilla, pistachio, pomegranate, plum, pumpkin, rape (canola), raspberry, rice bran, safflower, sesame, soybean, starflower (borage), strawberry, sunflower, walnut, watermelon, wheat, wheat germ. “Seed” is not limited to whole seeds and includes seed that has already been partly processed or ruptured in ways that do not negate the benefits of the apparatuses and methods disclosed herein and also includes seeds that may remain attached to other plant parts, either singly or in groups. “Seeds” may include isolated parts of seeds (including endosperm, pericarp, endocarp, mesocarp, exocarp, testa, cotyledons, embryos, ruminate bodies, ovary wall) and may include associated plant parts or other plant tissues such as branches, leaves, stalks, calyx, stems and roots that may be associated with seeds or may partly or completely enclose or may otherwise be associated with the seed. Seeds may be dormant, or may be partly or fully germinated and may be from one plant species or may be a combination of different species.

Seed may be substantially clean and free of other seeds, chaff and other particulate contaminants, or may be more than about 70% pure, more than about 80% pure, more than about 90% pure, more than about 95% pure, more than about 96% pure, more than about 97% pure, more than about 98% pure, more than about 99% pure or more. The seed may be of food grade and may be more than 99% pure and may be 99.9% pure.

In this disclosure the term “stable” or “substantially stable” or “highly stable” is intended to mean resistant to change, deterioration or degradation and by way of illustration includes plant oils and plant oil extracts that do not substantially undergo degradation or change over an extended period. In particular embodiments the plant oils disclosed herein may remain stable for periods of up to about six months, or up to about 1, 2, 3, 4, 5, 6, 7, 8, 9, 10, 11, 12, 13, 14, 15, 16, 17, 18 or more years. In certain embodiments the plant oils may remain stable for one or more of these periods at about ambient temperature or at about atmospheric pressure, or at lower than ambient temperature or lower than ambient pressure, or at higher than ambient temperature or higher than atmospheric pressure. In particular embodiment this stability may be exhibited at temperatures above about 4° C., above about 10° C., 15° C., 20° C., 25° C., 30° C., 35° C., 40° C., 50° C., 60° C., 70° C., 80° C. or 90° C. or above. In particular embodiments this stability may be exhibited under conditions wherein oxygen or other reactive gases or chemicals, or where water or humidity are excluded. It will be understood that the achievement of any high levels of stability requires and assumes suitable conditions are maintained in any storage facility or container that may be used.

In this disclosure the terms “undetectable” and “substantially undetectable” mean that the component or chemical referred to is not detected in measurable amounts by standard testing procedures. Such standard testing procedures may include the use of Thin Layer Chromatography, High Performance Liquid Chromatography, Gas Chromatograpy and Gas Liquid Chromatography, all of which will be readily understood and implemented by those skilled in the art.

In this disclosure, unless the context clearly dictates otherwise, the singular of a term imports the plural and the plural imports the singular and the term “or” is understood to be inclusive of all possibilities recited and does not imply that any of the alternatives necessarily excludes another.

### First Embodiment

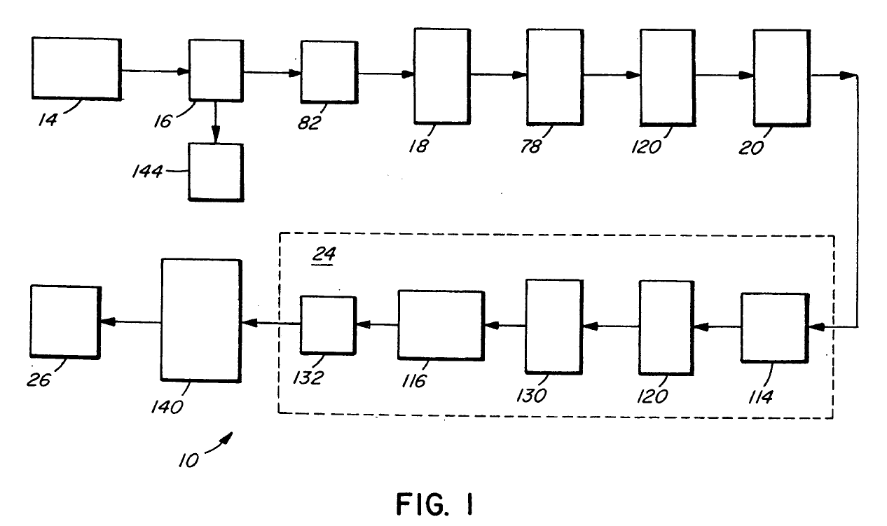

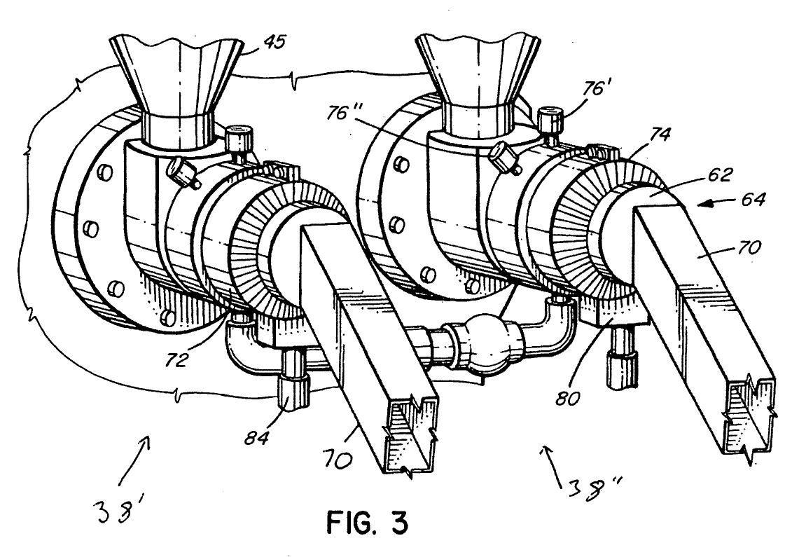

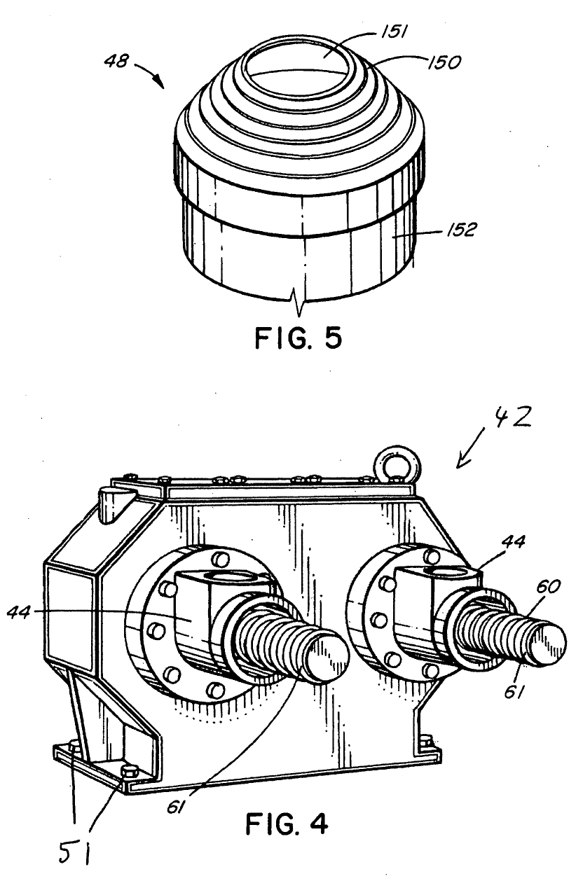

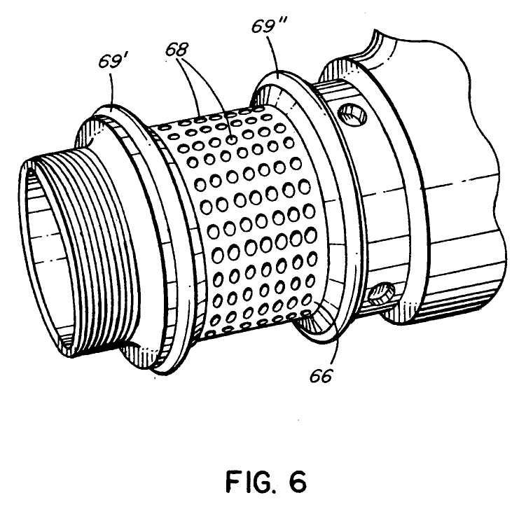

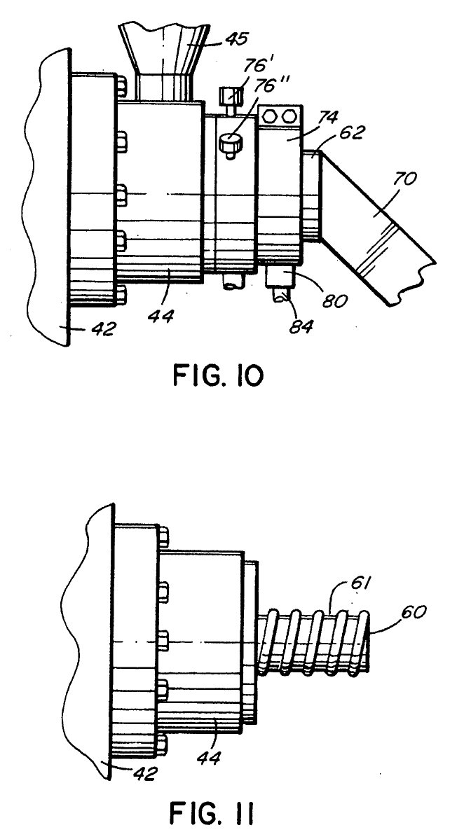

A first embodiment is described generally with reference to FIGS. 1 through 11. The embodiment generally designated 10 may comprise or may comprise the use of an apparatus comprising a seed intake unit 14 and a seed milling unit 16, which may comprise a seed press 42 itself comprising one or more press heads 38, and may be operatively connected to the seed intake unit 14 for receiving the seed, which may be flax seed, from seed intake unit 14 and producing a first plant oil extract. The apparatus and method may substantially prevent exposure of the plant oil to oxygen and other reactive gases. This may be achieved by displacing the oxygen or other reactive gases, which may be air, using introduced inert gases and the apparatus may comprise suitable airtight seals to prevent the inflow of atmospheric gases. The apparatus and method may also prevent exposure of the oil to a predetermined range of electromagnetic radiation, which may include visible light and may include blue, red, ultraviolet and infra red light, and the exclusion may be achieved by the choice of suitable materials impermeable or substantially impermeable to such radiation all of which will be readily apparent to those skilled in the art. Thus the apparatus and method may ensure that the oil remains in darkness and protected from oxygen throughout processing. The apparatus may also prevent exposure of the oil to electrostatic charges, electrical currents and electrical charge, which may be achieved by independent grounding of elements of the apparatus. The apparatus may also comprise a concentrating unit 24 which may comprise a distilling unit 116, which may comprise an evaporator or a molecular still. The concentrating unit 24 may be useable to separate the plant oil from any lignans in the plant oil extract. In embodiments the apparatus may heat the oil to a predetermined temperature for a predetermined time. The predetermined temperature may be greater than about 75° C. and the predetermined time may be greater about 5 seconds. Although the seed may comprise flax, sunflower, olive or grapeseed those skilled in the art will readily adapt the conditions described to suit particular alternative choices of seeds and oils. The embodiment generally prevents contact between the plant oil or plant oil extract, and reactive surfaces. Thus parts of the apparatus that may be exposed to the plant oil or plant oil extract may be made of nonreactive materials such as teflon coated rubber or stainless steel. A range of suitable alternatives will be readily apparent to those skilled in the art. The oil produced by embodiments may be highly stable and may have low moisture content and low peroxide values. The oils produced by the embodiment may be partly or highly pure, and may be suitable for human consumption and may be useable for incorporation into food supplements such as pills, liquids, nutritional bars and other dosage forms.

The entire apparatus may be modified atmosphere capable and made of light excluding material. Individual parts of the apparatus may be independently atmosphere controllable or capable of being isolated for maintenance purposes by providing suitable isolation valves and gas input valves 21 and gas outflow valves 22. In embodiments the oil may be packaged into suitable containers in a packaging unit 26 that may continue the protective conditions set forth above for the embodiment as a whole and the containers may similarly be adapted to exclude electromagnetic radiation, reactive gases and the like. Individual parts of the apparatus or groups of parts may be independently grounded to prevent circulating currents, ion gradient sweep and other electrostatic or electrochemical processes that might tend to form radicals or ions within the oil. Parts or all of the apparatus may be five wire grounded, with a neutral wire and a ground. In an embodiment a Bently Nevada Proximitor® 7200,9000, or 3300 may be used to achieve the grounding but alternatives will be readily apparent to those skilled in the art.

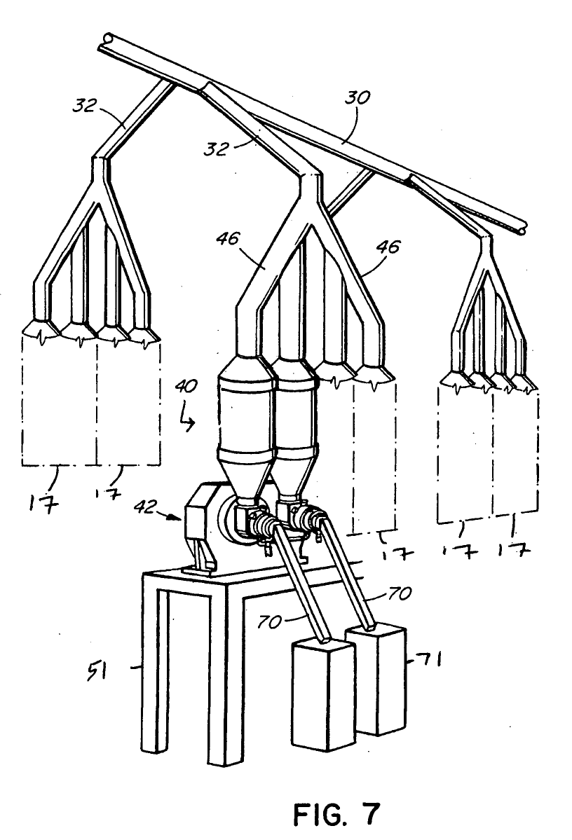

As seen particularly in FIG. 7, seed is fed through a feedline 30 to any one of a plurality of distribution pipes 32 to deliver the seed into a milling unit 16. It will be understood that in alternative embodiments, pneumatic blowpipe systems, auger systems, conveyors, gravity feed, and a variety of other feed systems may be used, all of which will be readily understood by those skilled in the art. The seed may be magnetically cleaned before delivery to the milling units 16. A milling unit 16 may comprise one or more press units 42 which may comprise one, two, three, four, five or more press heads 38 each with an associated hopper 40 to receive seed for feeding into the press head 38. An individual hopper 40 may comprise a cylinder 45 of polycarbonate or other suitable material and may be closed by a sealing boot 48 made of EDPM or other suitable material to exclude air and contain any introduced inert gases. A funnel 49 or other suitable device channels the seed to the press head 38. In some embodiments the seed may be actively dispersed and mixed with an inert gas as it is fed into the hopper. A boot 48 may comprise a top part 150 comprising, a lower sleeve 152 to sealingly fit cylinder 45, and an opening 151 to receive feed pipe 46. The combination of press 42 and its associated hopper assembly and output is generally designated 17 and for simplicity, repeated iterations are represented by numbered boxes in FIG. 7.

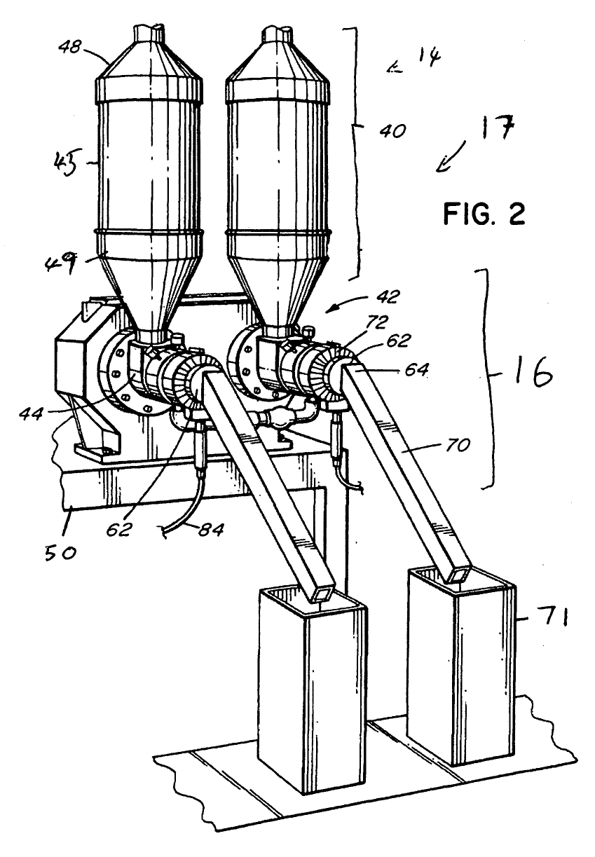

As shown particularly in FIGS. 2, 3, 4, 6, 10 and 11 a press head 38 may comprise a body 44 and an auger 60 to move and compress the seed and to crack the seed against an anvil 62. Milling unit 16 may comprise one or more press units 42 which may be mounted on supporting frames 50 to which they may be secured using suitable bolts 51. In embodiments the augers 60 (shown particularly in FIGs. and 11) may have groove 61 dimensions from about 1 2 mm, 2 3 mm, 3 4 mm, 4 5 mm, 5 6 mm, 6 7 mm, 7 8 mm, 8 9 mm, 9 10 mm, 10 11 mm, 11 12 mm, 12 13 mm, 13 14 mm, 14 15 mm, 15 16 mm, 16 17 mm, 17 18 mm, 18 19 mm, 19 20 mm, 20 21 mm, 21 25 mm, or 25 30 mm. Alternatively these possible alternatives may be designated by conventional R numbers and may be from about R1 to about R2, about R2 to about R3, about R3 to about R4, about R4 to about R5, about R5 to about R6, about R6 to about R7, about R7 to about R8, about R8 to about R9, about R9 to about R10, about R10 to about R11, about R11 to about R12, about R12 to about R13, about R13 to about R 14, about R14 to about R 15, about R15 to about R16, about R16 to about R17, about R17 to about R 18, about R18 to about R19, about R19 to about R20, about R20 to about R21, about R21 to about R25, or about R25 to about R30, or any other suitable dimensions, all of which will be readily identified by those skilled in the art. In operation the auger 60 is rotated inside a perforated cylinder 66 (which may also be referred to as an extruder barrel) having holes 68 for draining off oil liberated by the cracked seed. The perforated cylinders 66 may be enclosed in a press cowl 72 with the cowl 72 and cylinder 66 defining therebetween a space into which the oil flows from the crushed seed. The junction between the cowl 72 and the cylinder 66 may be sealed by O rings 69 or other suitable structures. The de-oiled cake may be expelled at the end 64 of the press into a channel 70 from which it may pass to receiver 71 and thence to a hammer mill to be pressed into a desired form of seed cake.

The press heads 38 may be temperature regulated. In embodiments the temperature regulator may simply perform an initial heating step and by way of example, in embodiments the heater may establish a starting temperature of about 40° C., 41° C., 42° C., 43° C., 44° C., 45° C., 46° C., 47° C., 48° C., 49° C., or 50° C. and then be switched off. Where the seeds are flax seeds the cracked oil may leave the press head at temperature of between about 40° C. and about 50° C., or between about 43° C. and about 49° C., or between about 45° C. and about 47° C., or may be lower than about 47° C., lower than about 49° C., lower than about 51°° C., lower than about 53° C. or lower than about 55° C. In some embodiments it may not be necessary to perform any further temperature regulation and the press 42 may be allowed to operate at suitable speed without additional heating or cooling. A thermistor type temperature regulator or other temperature regulator may be applied at the end of the press head 38 to keep the temperature of the oil below about 45° C., 46° C., 47° C., 48° C., 49° C., 50° C., 51° C., 52° C., 53° C., 54° C., 55° C., 56° C., 57° C., 58° C., 59° C., 60° C. or 61° C. It will be appreciated that in alternative embodiments the temperature of the press head 38 and of the oil may be regulated to accommodate the influence of the speed of rotation of the auger 60 which may have the effect of heating the oil. The press cowl 72, illustrated particularly in FIG. 2, may comprise external grooves to accommodate the temperature regulation apparatus 76, which may include a cooling water flow, a thermistor or other suitable device. The cowl 72 may comprise one or more gas valves or ports 76 to prevent a buildup of gas pressure may be used to actively introduce or control the composition and pressure of the gas atmosphere in the press head 38. The press cowls 72 may have an inner baffle that is maintained at a suitable temperature to prevent the steam from condensing on the cowl and dripping in to the fresh oil in ways understood by those skilled in the art.

The press heads may be asymmetric and may have a high compression side and may have a low compression side which has relatively more space between the press wall and the cylinder. In embodiments an inert gas which again may be or may comprise Argon or Nitrogen may be fed in from the low compression side or from other locations. A backflow of inert gas may be sustained from the surge tank 78 or other parts of the apparatus through the press heads 38. The correct balance of gas backflow from the surge tank 78, and speed of operation of the press heads 38 and the location of gas feeds may be important to the effectiveness of the cracking process and the quality of the oil recovered. The optimal combination for specific seed types and specific oils will be readily determined by those skilled in the art.

In some applications, such as in the processing of flax seed, it may only be the upper end of the temperature range of the press head 38 that is controlled and temperature control may only prevent overheating and the temperature regulator or heater may comprise a simple metal heating coil. When the seed to be and in embodiments the milling unit 16 and press heads 38 may be run so as to keep the seed temperature between 47° C. and 175° C., or above about 47° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C. or higher or below about 175° C., 160° C., 130° C., 120° C., 110° C., 100° C., 90° C., 80° C., 70° C., 60° C., 50° C., 40° C., 30° C., 20° C., 10° C., 5° C., or lower. While the quality of some oils may benefit from being kept at relatively low temperatures, others may tolerate higher temperatures, including temperatures of up to about 60° C., up to about 70° C., up to about 80° C., up to about 90° C., up to about 100° C. up to about 110° C., 150° C., 200° C., 250° C. or higher. The plant oil extract liberated by the press head 38 leaves the sink 80 in the belly of the press cowl 72 and may optionally be piped through a cooling coil chamber 82 to quickly lower its temperature before flowing to the surge tank 78. A conventional control system may be incorporated in the apparatus to control the heaters 74 and auger 60 speed within specified ranges to keep temperature, pressure and/or other variables within desired parameters and to track the functioning of the apparatus and status of tanks, silos etc.

From the press heads 38 the cracked oil extract flows into a press output line 84 and thence to a surge tank 78. In the embodiment illustrated the output from four associated press heads 38 may all feed into a single stainless steel surge tank 78 of about 400 litres capacity. To remove residual solids from the freshly cracked oil a decanter may be positioned between the press heads 38 and the surge tank 78 or a series of stepped weirs may be provided in the press output line 84 or in the surge tank 78 itself.

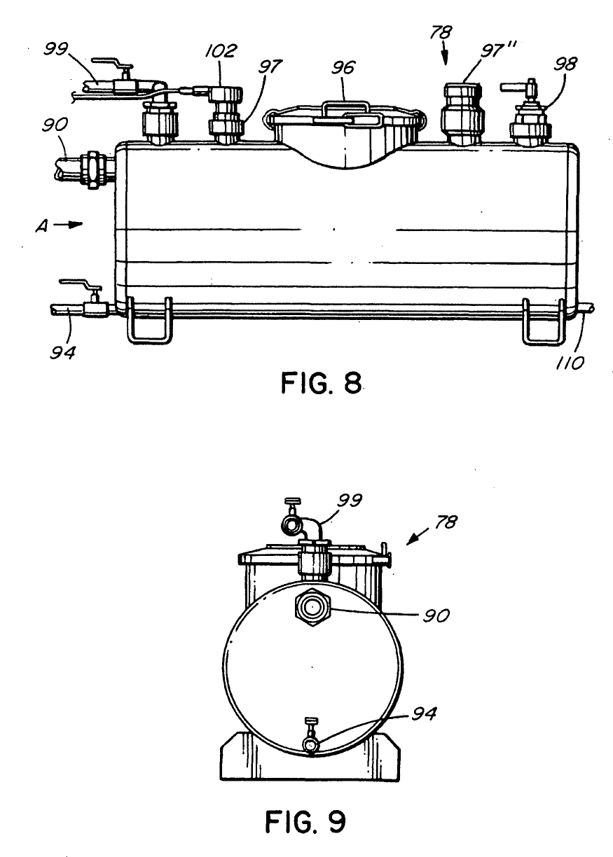

As will be seen from FIGS. 8 and 9, the surge tank 78 may be fed from a raised inflow port 90 and may be tilted towards one end so that any solids are concentrated and readily removed without being drawn into the outflow 110 and to minimize exposure of the oil thereto. The tank 78 may also be fed with inert gas and may maintain a slight positive pressure in the surge tank 78 causing a reverse flow of inert gas back towards the press heads 38 which may help to remove any residual steam from the pressed oil as well as serving a cooling function and again helping to exclude atmospheric oxygen in the press heads 38 and the press output lines 84. The surge tank 78 may be sparged with inert gas using a ceramic sparger fed by a suitable gas line 94. The surge tank 78 may be provided with an inspection and cleaning access point 96, a gas input 99, a pressure relief and gas outflow valve 98 to bleed off displaced gasses. A control sensor 102 may be provided and inserted through the top of the tank 78 through further monitoring port 97. The various possible adaptations and design features of the surge tank will be readily understood and applied by one skilled in the art. From the surge tank 78 the oil extract flows through output and line 110 and to a concentrating unit 24.

Concentrating unit 24 may comprise a clarifier 114 to remove the initial bulk of particulate matter and may also or may alternatively comprise a distillation unit 116 to enrich the plant oil content of the pressed oil. In the first embodiment the concentrating unit 24 may comprise or be associated with a clarifier 114 and distillation unit 116. In particular embodiments the clarifier 114 may be a cyclone separator which may be a Wesfalia™ MODEL TTA50-02-066 automatic desludging type (or equivalent) or an Alpha Laval™ clarifier and distillation unit 116 may be or may comprise a molecular still which may be a Pope™ wiped film molecular still. Extracted solids are disposed of through a waste output and the clarified oil passes into a clarifier output line and thence to a batch tank 120. The batch tanks 120 fed from clarifier 114 may be 20,000 litre volume tanks and may be two layered tanks with a dark outer layer to exclude light and an inner surface that is non-reactive and suitable to preserve the oil. The clarified oil may now be pumped through a biological barrier filter system 130 comprising one or more filtration chambers to remove any bacteria, yeasts, spores and other biologically active contaminants. In some embodiments the oil may pass through one, two, three, four, five, six or more layers of filters which may have sequentially decreasing pore sizes. Filters may be gradient filters and may have pore sizes of between about 0.01 and 0.1 microns, between about 0.1 and 0.2 microns, between about 0.2 and 0.3 microns, between about 0.3 and 0.4 microns, between about 0.5 and 0.6 microns, between about 0.6 and 0.7 microns, between about 0.7 and 0.8 microns, between about 0.8 and 0.9 microns, between about 0.9 and 1.0 microns, 1.1 and 1.2 microns, between about 1.2 and 1.3 microns, between about 1.3 and 1.4 microns, between about 1.5 and 1.6 microns, between about 1.6 and 1.7 microns, between about 1.7 and 1.8 microns, between about 1.8 and 1.9 microns, between about 1.9 and 2.0 microns, 2.1 and 2.2 microns, between about 2.2 and 2.3 microns, between about 2.3 and 2.4 microns, between about 2.5 and 2.6 microns, between about 2.6 and 2.7 microns, between about 2.7 and 2.8 microns, between about 2.8 and 229 microns, between about 2.9 and 3.0 microns, 3.1 and 3.2 microns, between about 3.2 and 3.3 microns, between about 3.3 and 3.4 microns, between about 3.5 and 3.6 microns, between about 3.6 and 3.7 microns, between about 3.7 and 3.8 microns, between about 3.8 and 3.9 microns, between about 3.9 and 4.0 microns, 4.0 and 5.0 microns, between about 5 and 6 microns, between about 6 and 7 microns, between about 7 and 7 microns, between about 8 and 9 microns, between about 9 and 10 microns, or greater than 10 microns. In embodiments removal of biologically active contaminants may also be achieved by alternative methods such as the introduction of suitable sterilizing agents, ultracentrifugation, ultrasonication and the like.

After removing bacteria and other biologically active contaminants or sediments the oil may be distilled by a distillation unit 116 to enrich and/or purify it. This stage of the process may include two steps, a first step to remove more volatile components and a second to complete the purification of the desired oil or plant oil. The flow rate, temperature, pressure and wiper speed of the distillation unit are adapted to suit the oil to be processed in ways that will be readily apparent to those skilled in the art. In alternative embodiments where the distillation unit 116 is a molecular still, this may be run under a vacuum of greater than about 100 torr, greater than about 90 torr, greater than about 80 torr, greater than about 70 torr, greater than about 60 torr, greater than about 50 torr, greater than about 40 torr, greater than about 30 torr, greater than about 20 torr, greater than about 10 torr, or greater than about greater than about 5 torr. Alternatively in embodiments, the vacuum may be of a pressure of less than about 80% of atmospheric pressure or less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, less than about 10%, less than about 5% or less of normal atmospheric pressure. In embodiments the running temperature of the wiped film surface may be below about 80° C., below about 70° C., below about 60° C., below about 50° C., or below about 40° C. In alternative embodiments a variety of maximum temperatures may be chosen and the treatment cycle may incorporate a short period of higher temperature under high vacuum which may be a period of less than about 60 s, less than about 50 s, less than about 40 s, less than about 35 s, less than about 30 s, less than about 25 s, less than about 20 s, less than about 19 s, less than about 18 s, less than about 17 s, 16 s, less than about 15 s, less than about 14 s, less than about 13 s, less than about 12 s, less than about 11 s, less than about 10 s, less than about 9 s, less than about 8 s, less than about 7 s, less than about 6 s, less than about 5 s, less than about 4 s, less than about 3 s, less than about 2 s or less than about 1 s (seconds). In embodiments the short period of elevated heat may be at temperatures of up to about 60° C., up to about 70° C., up to about 80° C., up to about 90° C., up to about 100° C., up to about 110° C., up to about 120° C., up to about 130° C., up to about 150° C., up to about 160° C., up to about 170° C., up to about 180° C., up to about 190° C., up to about 200° C., up to about 210° C., up to about 220° C., up to about 230° C., up to about 240° C., up to about 250° C., up to about 260° C., up to about 270° C., up to about 280° C., up to about 290° C., up to about 300° C., up to about 310° C., up to about 320° C., up to about 330° C., up to about 340° C., up to about 350° C. or higher. In embodiments the heating may occur under vacuum levels of at least about at least about 1 torr, at least about 2 torr, at least about 3 torr, at least about 4 torr, at least about 5 torr, at least about 6 torr, at least about 7 torr, at least about 8 torr, at least about 9 torr, at least about 10 torr, at least about 11 torr, at least about 12 or more torr. Alternatively in embodiments, the vacuum may be of a pressure of less than about 80% of atmospheric pressure, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, less than about 10%, less than about 5% or less of normal atmospheric pressure. In embodiments the flow rate through the evaporator may be up to about 50, 100, 150, 200, 250, 300, 350, 400 or more litres a minute. The distillation unit may remove any residual water, light solvents, PCB's, pesticides, herbicides free fatty acids, odorous compounds, and other undesired chemicals. A cooler 132 may be provided following the distillation unit 116 to rapidly cool the processed oil back to lower temperatures that may approximate room temperature. The evaporated waste from the distillation unit 116 may be condensed using a chiller and collected in waste tank which may comprise a cooler to prevent the waste vapour from recontaminating the film distilled oil. Waste is then evacuated from the apparatus.

FIG. 1 generally shows the sequence of steps and components in an embodiment.

The parameters selected may be suitable to achieve oil with a low moisture content and a low peroxide value. In embodiments the resulting oil may have a Karl Fischer moisture level below about 10 ppm, below about 20 ppm, below about 30 ppm, below about 40 ppm, below about 50 ppm, below about 60 pm, below about 7 ppm, below about 8 ppm, below about 90 pm, or below about 100 ppm, below about 150 ppm, below about 200 ppm, below about 250 ppm, below about 300 ppm, below about 350 ppm, below about 400 ppm, below about 500 ppm, or below about 1000 ppm. In embodiments the prepared oil may have a Peroxide Value of less than about 100 meq/kg, less than about 90 meq/kg, less than about 80 meq/kg, less than about 70 meq/kg, less than about 60 meq/kg, less than about 50 meq/kg, less than about 40 meq/kg, less than about 30 meq/kg, less than about 20 meq/kg, less than about 15 meq/kg, less than about 14 meq/kg, less than about 13 meq/kg, less than about 12 meq/kg, less than about 11 meq/kg, less than about 10 meq/kg, less than about 9 meq/kg, less than about 8 meq/kg, less than about 7 meq/kg, less than about 6 meq/kg, less than about 5 meq/kg, less than about 4 meq/kg, less than about 3 meq/kg, less than about 2 meq/kg, or less than about 1 meq/kg.

In embodiments the oil may be highly stable and may be stable under suitable storage conditions for periods of greater than one, two, three, four or more years without substantial degradation in quality. In embodiments the oil may be free or substantially free of pesticides and herbicides or these components may be unquantifiable in the oil.

### Storage and Packaging:

The distilled oil is led out of the distillation unit through via an evaporator output to silos 140 for storage. The storage silos may be 20,000 litre tanks of essentially the same design as the batch tanks 120 described above. From the silos 140 the oil may flow into a silo output line to a packaging unit 26 and if desired oils may be mixed prior to packaging. In particular alternatives combinations of one or more of flax oil, sunflower oil and olive oil or any other desired oils may be mixed at this point. It will be understood that the oil may continue be maintained under an inert atmosphere and shielded from electromagnetic radiation, circulating currents and reactive materials all the way through the process and apparatus and as it is packaged. The oils may be packaged into containers under conditions which continue to exclude electromagnetic radiation, reactive gases and the like and the containers may be selected to maintain at least some of these protected conditions.

In some embodiments the yield of oil may be up to about 20%, up to about 25%, up to about 30%, up to about 35%, up to about 40%, up to about 45% or more of total starting weight of the seed and yield may vary depending on whether wet or dry seed is used.

In alternative embodiments the method and apparatus may comprise incorporating cooling channels into the auger or other parts of the press head; providing a cooling jacket for the freshly extracted oil; modifying the speed of the press; modifying the auger to increase the number of turns or maintaining an active flow of inert gas through part of the apparatus through low pressure suction.

In embodiments filters may be inserted into the lines between parts of the apparatus and may include 1, 2, 3, 4, 5, 6, 7, 8, 9 micron filters or may have larger or smaller pore sizes. Suitable brands of filter may include filters by Filter Media. In embodiments it may be preferred to avoid polypropylenes, nylon and other materials that may absorb moisture.

The lines and connections between elements of the apparatus may be teflon coated plastic, polyethylene, rubber or other suitable materials, but in all cases they may be selected from materials that electrically isolate one piece of apparatus from another so that the individual elements may be separately grounded as previously indicated and may be selected to be non reactive with the oil. Pumps may be selected to minimize damage to the plant oils, and peristaltic pumps may be selected in some embodiments to minimize shearing forces on the plant oils. Double valve assemblies may be provided at one or more points in the apparatus so that portions of the apparatus may be isolated for cleaning or other purposes whilst the remainder of the apparatus is maintained in its modified atmosphere state.

The system overall may be controlled and monitored using an Allen Bradley PLC control system. An operator may be able to remotely determine the status and content of different tanks, valves etc. Data is exportable and wirelessly accessible.

In embodiments the whole production line may generally be operated in a controlled temperature environment. The ambient or room temperature may be kept at about 0 5° C., about 5 10° C., about 10 15° C., about 15 20° C., about 20 25° C., about 25 30 C., about 30 35° C. or greater. Because of the use of large quantities of nitrogen and/or other inert gases suitable monitoring systems may be used to warn of any fall in ambient oxygen levels. While the embodiment illustrated shows one possible combination of components of the system it will be understood that the specific numbers, sizes, capacities and flow rates and other parameters of the system may be adjusted depending on the quantities processed, the oil to be processed, and specific requirements. Those skilled in the art will be readily able to adapt the details of the disclosed methods, reagents and apparatus for use with a range of plant oils and oils having different physical properties. It will be understood that the foregoing precautions and adaptations may be applied to individual portions of the apparatus separately or may be applied to the apparatus as a whole. For instance, light may be excluded by placing the entire apparatus or live parts thereof in a darkened room, or large parts of the process may be conducted in sealed rooms or a factory with a modified atmosphere, lighting, or electrical environment.

In embodiments the oils prepared using the methods and apparatus of embodiments may be highly stable and may be substantially or essentially free of pesticides and herbicides.

### Second Embodiment

In a second embodiment there is disclosed a plant oil produced according to the methods of the first embodiment. The plant oils prepared using the methods and apparatuses set out herein may contain reduced levels of herbicides, pesticides and other contaminants. In embodiments the levels of pesticides and/or herbicides in the plant oil may be minimal and may be below about 0.0001 ppm, below about 0.001 ppm, below about 0.01 ppm, below about 0.1 ppm, below about 1 ppm, below about 10 ppm, below about 100 pm or higher and in embodiments pesticides and herbicides may be undetectable or substantially undetectable or unmeasurable. In embodiments the oil may have a low moisture content, may have a low peroxide value, and may be highly stable. The oils may have the properties set forth herein for other alternative embodiments.

### Third Embodiment

In a third embodiment there is disclosed a plant oil having less than about 200 ppm Karl Fischer Moisture. In alternative embodiments the Karl Fischer Moisture content of the oil may be less than about 500 ppm, less than about 400 ppm, less than about 300 ppm, less than about 275 ppm, less than about 250 ppm, less than about 225 ppm, less than about 200 ppm, less than about 175 ppm, less than about 150 ppm, less than about 125 ppm, less than about 100 ppm, less than about 75 ppm, less than about 50 ppm, or less than about 25 ppm.

In embodiments the oil may have a Peroxide Value of less than about 100 meq/kg, less than about 90 meq/kg, less than about 80 meq/kg, less than about 70 meq/kg, less than about 60 meq/kg, less than about 50 meq/kg, less than about 40 meq/kg, less than about 30 meq/kg, less than about 20 meq/kg, less than about 15 meq/kg, less than about 14 meq/kg, less than about 13 meq/kg, less than about 12 meq/kg, less than about 11 meq/kg, less than about 10 meq/kg, less than about 9 meq/kg, less than about 8 meq/kg, less than about 7 meq/kg, less than about 6 meq/kg, less than about 5 meq/kg, less than about 4 meq/kg, less than about 3 meq/kg, less than about 2 meq/kg, less than about 1 meq/kg, less than about 0.9 meq/kg, less than about 0.8 meq/kg, less than about 0.7 meq/kg, less than about 0.6 meq/kg, less than about 0.5 meq/kg, less than about 0.4 meq/kg, less than about 0.3 meq/kg, less than about 0.2 meq/kg, or less than about 0.1 meq/kg,

In embodiments the oil may be flax, olive, sunflower or grapeseed oil and in embodiments the oil may have a composition comprising the components as described in Table 1.

TABLE 1
Composition of Oils Produced in Alternative Embodiments

| Parameter | Range in alternative embodiments |
|---|---|
| Peroxide value | Any value from about 0.00 to about 50.00 |
| | meq/kg or more |
| Free Fatty Acids | Any value from about 0.00 to about 50.00% or more |
| Karl Fischer | Any value from about 0.00 to about 50.00% or more |
| Moisture | |
| Sterols and stannols | Any value from about 0.00 to about 5000.00 |
| | mg/g or more |
| Sterols and | Any value from about 0.00 to about 5000 |
| tocopherols | mg/100 g or more |

In embodiments the oil may be a highly stable plant oil extracted from a seed in the absence of oxygen, and light and may be stable for longer than two years. In embodiments pesticides and herbicides may be essentially undetectable in the oil. In embodiments the oil may comprises an omega 3 oil or an omega 6 oil or may comprise flax oil, olive oil, sunflower oil, grapeseed oil or sesame oil. In embodiments the oil may be suitable for human consumption, may be substantially stable for three years, may be essentially free of pesticides and herbicides, and may have less than about 100 pm Karl Fischer Moisture. In alternative embodiments the oil may be included in a plant extract, or may be included in a nutritional supplement, a nutritional bar or the like. In alternative embodiments the plant oil may have low moisture content, low peroxide value and be highly stable.

### EXAMPLES

In a First example, there is described a flax seed oil having the composition set out in Table 2 which may be made according to the first embodiment.

TABLE 2
Flax Oil Composition

| Peroxide Value | 0.72 | meq/kg |
|---|---|---|
| Free Fatty Acids | 0.24% | |
| Karl Fischer Moisture | 43.5 | ppm |
| Campesterol | 0.77 | mg/g |
| Campestanol | <0.50 | mg/g |
| Sitosterol | 1.10 | mg/g |
| Sitostanol | <0.50 | mg/g |
| Other sterols and stannols | 1.39 | mg/g |
| delta Tocopherol | 0.47 | mg/100 g |
| gamma Tocopherol | 35.7 | mg/100 g |
| alpha Tocopherol | 1.17 | mg/100 g |
| Campesterol | 110 | mg/100 g |
| Stigmasterol | 27.4 | mg/100 g |
| B-sitosterol | 198 | mg/100 g |

In an Second example, there is described a sunflower oil having the composition shown in Table 3 which may be made according to the first embodiment.

TABLE 3
Sunflower Oil Composition

| Peroxide Value | 5.50 | meq/kg |
|---|---|---|
| Free Fatty Acids | 0.32% | |
| Karl Fischer Moisture | 47.1 | ppm |
| Campesterol | <0.50 | mg/g |
| Campestanol | <0.50 | mg/g |
| Sitosterol | 1.54 | mg/g |
| Sitostanol | <0.50 | mg/g |
| Other sterols and stannols | <0.50 | mg/g |
| delta Tocopherol | 0.20 | mg/100 g |
| gamma Tocopherol | 0.83 | mg/100 g |
| alpha Tocopherol | 60.4 | mg/100 g |
| Campesterol | 40.0 | mg/100 g |
| Stigmasterol | 29.1 | mg/100 g |
| B-sitosterol | 212 | mg/100 g |

In a Third example there is disclosed an olive oil having the composition set out in table 4 which may be made according to the first embodiment.

TABLE 4
Olive Oil Composition

| Peroxide Value | 8.32 | meq/kg |
|---|---|---|
| Free Fatty Acids | 0.15% | |
| Karl Fischer Moisture | 46.7 | ppm |
| Campesterol | <0.50 | mg/g |
| Campestanol | <0.50 | mg/g |
| Sitosterol | 0.92 | mg/g |
| Sitostanol | <0.50 | mg/g |
| Other sterols and stannols | <0.50 | mg/g |
| gamma Tocopherol | 0.61 | mg/100 g |
| alpha Tocopherol | 14.8 | mg/100 g |
| Campesterol | 9.28 | mg/100 g |
| Stigmasterol | 1.15 | mg/100 g |
| B-sitosterol | 153 | mg/100 g |

The embodiments and examples presented herein are illustrative of the general nature of the subject matter claimed and are not limiting. It will be understood by those skilled in the art how these embodiments can be readily modified and/or adapted and/or combined for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

The embodiments of the invention in which an exclusive property or privilege is claimed are defined as follows:

1. A highly stable plant oil having a low moisture content and low peroxide value.

2. The plant oil according to claim 1 wherein the oil is stable for longer than about two years, and has less than about 200 ppm Karl Fischer moisture.

3. The oil according to claim 1 comprising less than about 200 ppm Karl Fischer Moisture.

4. The oil according to claim 3 comprising less than about 100 ppm Karl Fischer Moisture.

5. The oil according to claim 3 having a peroxide value of less than about 10 meq/kg.

6. The oil according to claim 2 wherein the oil is prepared in the substantial absence of oxygen and light.

7. The plant oil according to claim 2 having a peroxide value of less than about 10 meq/kg.

8. The oil according to claim 2 wherein the oil is flax oil, olive oil, sunflower oil, or grapeseed oil.

9. The plant oil according to claim 2 wherein herbicides and pesticides are undetectable in the oil.

10. A plant oil according to claim 1 wherein said oil is suitable for human consumption, substantially stable for at least three years, being essentially free of pesticides and herbicides, and having less than about 100 ppm Karl Fischer Moisture and less than about 10 meq/kg peroxide value.

11. A method for extracting a plant oil from a seed, said method comprising disrupting said seed and preparing an extract containing said plant oil under conditions which substantially prevent exposure of said oil to reactive gases and to predetermined wavelengths of electromagnetic radiation.

12. The method according to claim 11 further comprising preventing exposure of said oil to electrical currents.

13. The method according to claim 11 further comprising removing lignans from said extract.

14. The method according to claim 11 further comprising displacing said reactive gas with an inert gas.

15. The method according to claim 14 wherein said inert gas comprises Nitrogen, Argon or Carbon Dioxide.

16. The method according to claim 11 wherein said electromagnetic radiation includes visible light.

17. The method according to claim 11 wherein said plant oil is heated to a temperature of greater than about 75° C. for a predetermined time.

18. A plant oil produced by a process comprising the steps of:
disrupting a seed; and
preparing an extract containing said plant oil under conditions which substantially prevent exposure of said oil to reactive gases and to predetermined wavelengths of electromagnetic radiation.

19. The plant oil produced according to claim 18, wherein said electromagnetic radiation includes visible light.

20. Apparatus for isolating a plant oil from a seed, said apparatus comprising:
a seed intake unit; and
a seed milling unit operatively connected to the seed intake unit for receiving seed from said seed intake unit and producing a first plant oil extract,
wherein said apparatus substantially prevents exposure of said plant oil to:
oxygen; and
a predetermined range of electromagnetic radiation.

21. The apparatus according to claim 20 wherein said apparatus also prevents exposure of said oil to electrostatic charges.

22. The apparatus according to claim 20 wherein said apparatus comprises an evaporator to separate said plant oil from any lignans comprised in said plant oil extract.

23. The apparatus according claim 20 wherein said predetermined range of electromagnetic radiation includes visible light.

24. The apparatus according to claim 20 wherein atmospheric air is displaced by an inert gas to substantially prevent contact between said oil and atmospheric oxygen.

25. The apparatus according to claim 24 wherein said inert gas comprises Nitrogen, Argon or Carbon Dioxide.

26. The apparatus according to claim 20 wherein said apparatus heats said plant oil to a temperature of greater than about 75° C. for a predetermined time.

27. A plant oil produced by a process comprising using apparatus for isolating a plant oil from a seed, said apparatus comprising:
a seed intake unit; and
a seed milling unit operatively connected to the seed intake unit for receiving seed from said seed intake unit and producing a first plant oil extract,
wherein said apparatus substantially prevents exposure of said plant oil to:
oxygen; and
a predetermined range of electromagnetic radiation, and
wherein said inert gas comprises Nitrogen, Argon or Carbon Dioxide.

28. The plant oil according to claim 27 wherein the seed is selected from the group consisting of: flax, grape, sunflower and olive seeds.
